(19) United States
(12) Patent Application Publication
(10) Pub. No.: US 2014/0289664 A1
(43) Pub. Date: Sep. 25, 2014

(54) PORTABLE TERMINAL DEVICE, NON-TRANSITORY STORAGE MEDIUM AND METHOD FOR SUPPRESSING IMPLEMENTATION

(71) Applicant: KYOCERA Corporation, Kyoto-shi, Kyoto (JP)

(72) Inventors: Hiroaki Honda, Yokohama-shi (JP); Yoshihiko Inaoka, Daito-shi (JP)

(21) Appl. No.: 14/353,276

(22) PCT Filed: Oct. 19, 2012
(86) PCT No.: PCT/JP2012/077069

§ 371 Date: Apr. 21, 2014

(30) Foreign Application Priority Data
Oct. 20, 2011 (JP) 2011-230896

(51) Int. Cl. G06F 3/0488

(52) U.S. Cl. CPC G06F 3/04886
USPC 715/773

(57) ABSTRACT

A cellular phone includes a display surface, a touch sensor configured to accept an input with respect to the display surface and a CPU. The CPU displays a keyboard for inputting characters, an input text and a send button for executing a function for sending the input text as a message on the display surface. Further, the CPU executes a suppressing control for suppressing the execution of the function for sending the text as the message while one or more undetermined characters are included in the text displayed on the display surface.

### TECHNICAL FIELD

The present invention relates to a portable terminal device such as a cellular phone, a PDA (Personal Digital Assistant), a tablet PC, an e-book reader and so forth, and a program and a method for suppressing an implementation of the portable terminal device suitable for use in the portable terminal device.

### BACKGROUND ART

Conventionally, a portable terminal device having a function to send an input text to a recipient such as an E-mail, SMS (Short Message Service), a message memo, etc., is known. For example, inputting characters to pass the words to the recipient by key operation and performing a send operation, the text is sent as a sent message by the SMS.

### SUMMARY OF INVENTION

### Technical Problem

Incidentally, suppressing an incorrect operation at the time of the character input has been an existing problem.

For example, when a user is inputting characters by key operation, if the user performs a sending operation unintentionally, an unfinished text is sent as a message. As such, the text being sent before it is finished is undesirable for the user.

Then, the present invention aims to provide a portable terminal device, a program and a method for suppressing an implementation capable of suppressing an implementation of an unintended function while the user inputs characters.

### Solution to Problem

A first aspect of the present invention relates to a portable terminal device. The portable terminal device related to the first aspect includes a display surface, an accepting module configured to accept an input with respect to an image displayed on the display surface, a display control module configured to display a first image for inputting characters, one or more inputted characters and a second image for executing a predetermined function based on the one or more inputted characters on the display surface, and a suppressing module configured to execute a suppressing control for suppressing the execution of the predetermined function while one or more undetermined characters are included in displayed characters on the display surface.

A second aspect of the present invention relates to a program. The program related to the present aspect provides a computer of a portable terminal device including a display surface and an accepting module configured to accept an input with respect to the display surface with functions of, displaying one or more characters inputted through the accepting module and an image for executing a predetermined function based on the one or more inputted characters on the display surface, obtaining an input to the image as an input to execute the predetermined function, and suppressing the execution of the predetermined function while one or more undetermined characters are included in displayed characters on the display surface.

A third aspect of the present invention relates to a method for suppressing an implementation of a portable terminal device including a display surface and a accepting module configured to accept an input with respect to an image displayed on the display surface. The method for suppressing the implementation related to the present aspect includes steps of, displaying a first image for inputting characters, one or more inputted characters and a second image for executing a predetermined function based on the one or more inputted characters on the display surface, and suppressing the execution of the predetermined function while one or more undetermined characters are included in displayed characters on the display surface.

### Advantageous Effects of Invention

According to the present invention, it is possible to provide a portable terminal device, a program and a method for suppressing an implementation that are capable of suppressing an execution of a function a user does not intend to perform while the user inputs characters.

An advantage or significance of the present invention will become clearer from descriptions of the embodiments, as shown below. However, the following descriptions of the embodiments are simply one illustration in embodying the present invention, and the present invention is not limited by what is described in the following descriptions of the embodiments.

### BRIEF DESCRIPTION OF DRAWINGS

FIGS. 1(a) and 1(b) are diagrams showing an external arrangement of a cellular phone according to an embodiment.

FIG. 2 is a block diagram showing an overall configuration of the cellular phone according to the embodiment.

FIGS. 3(a) to 3(c) are diagrams showing transition examples of screens displayed when a control processing is executed according to the embodiment.

FIGS. 4(a) and 4(b) are diagrams showing transition examples of screens displayed when the control processing is executed according to the embodiment.

FIGS. 5(a) and 5(b) are diagrams showing transition examples of screens displayed when the control processing is executed according to the embodiment.

FIG. 6 is a flow chart for explaining a procedure for processing according to the embodiment.

FIG. 7 is a flow chart for explaining the procedure for processing according to a modification example 1.

FIGS. 8(a) to 8(d) are diagrams showing transition examples of screens displayed when the control processing is executed according to the modification example 1.

FIG. 9 is a flow chart for explaining the procedure for processing according to a modification example 2.

FIGS. 10(a) and 10(b) are diagrams showing transition examples of screens displayed when the control processing is executed according to the modification example 2.

FIGS. 11(a) and 11(b) are diagrams showing transition examples of screens displayed when the control processing is executed according to the modification example 2.

FIG. 12 is a flow chart for explaining the procedure for processing according to a modification example 3.

FIGS. 13(a) to 13(d) are diagrams showing transition examples of screens displayed when the control processing is executed according to the modification example 3.

FIG. 14 is a flow chart for explaining the procedure for processing according to a modification example 4.

FIGS. 15(a) to 15(d) are diagrams showing transition examples of screens displayed when the control processing is executed according to the modification example 4.

FIG. 16 is a flow chart for explaining the procedure for processing according to a modification example 5.

FIGS. 17(a) to 17(c) are diagrams showing transition examples of screens displayed when the control processing is executed according to other modification example.

The drawings are entirely used for an explanation for an example of the embodiments, and not intended to limit a scope of the present invention.

### DESCRIPTION OF EMBODIMENTS

In the following, regarding to the embodiments of the present invention will be described with reference to the drawings.

In the present embodiment, a touch sensor 12 corresponds to an “accepting module” recited in the claims. A text 21b corresponds to “inputted characters” recited in the claims. A keyboard 22 and a proposing window 26 configure a “first image” recited in the claims. A send button 23 corresponds to a “second image” recited in the claims. The proposing window 26 corresponds to a “third image” and a “fourth image” recited in the claims. A predicted word 27 corresponds to a “conversion candidate” and an “input candidate” recited in the claims. A CPU 100 corresponds to a “display control module” and a “suppressing module” recited in the claims. A communication module 107 corresponds to a “communication module” recited in the claims. It is noted that the description geared the above scope of the claims and the present embodiment is just one example, and it does not limit the scope of the claims to the present embodiment.

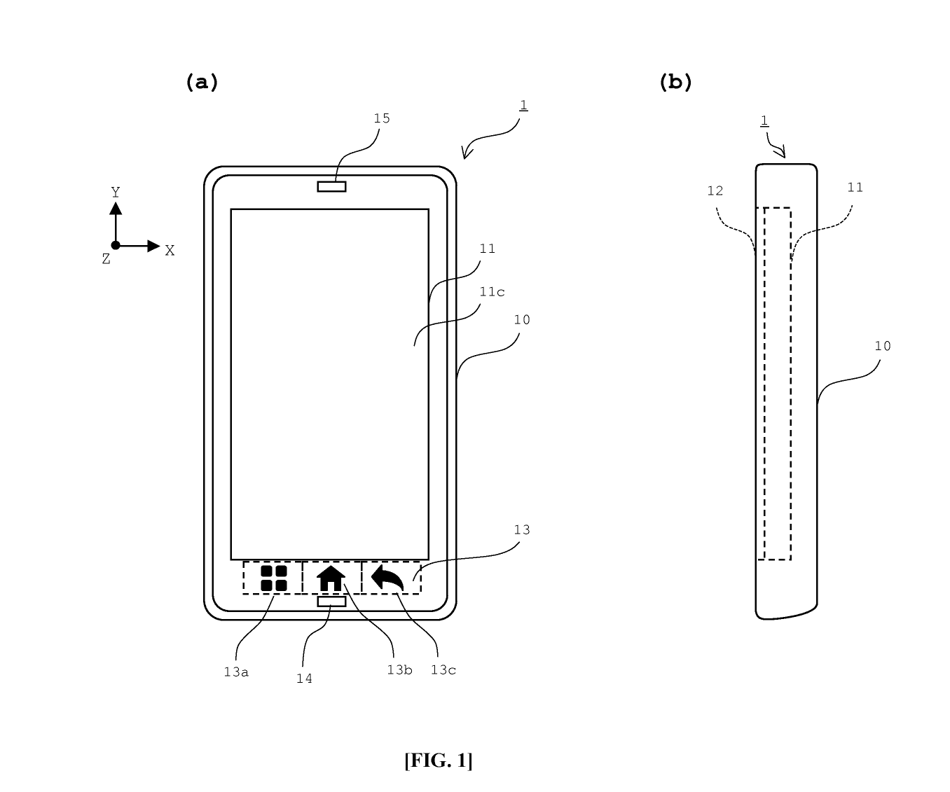

FIGS. 1(a) and 1(b) are diagrams showing external arrangement of a cellular phone 1. FIGS. 1(a) and 1(b) are a front view and a side view, respectively.

The cellular phone 1 has a cabinet 10 having a rectangular shape with small thickness. On the front side of the cabinet 10, a touch panel is arranged. The touch panel provides a display 11 and a touch sensor 12 being overlapped on the display 11.

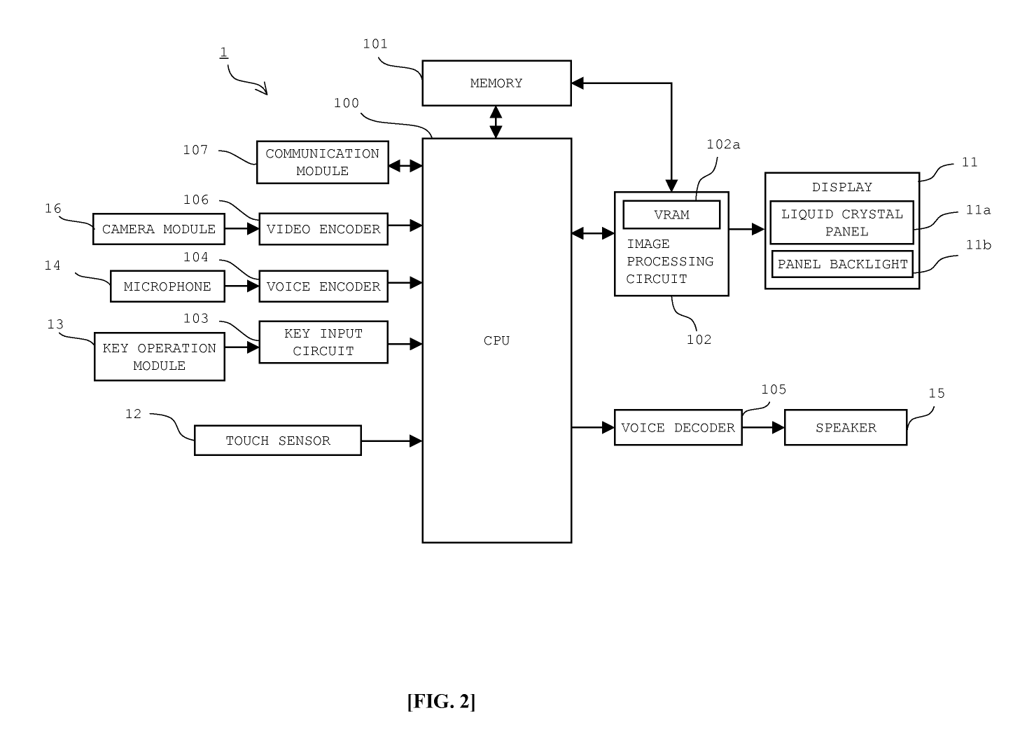

The display 11 is the liquid crystal display, and is composed of a later explained liquid crystal panel 11a and a panel backlight 11b which illuminates the liquid crystal panel 11a (see FIG. 2). The liquid crystal panel 11a includes a display surface 11c to display an image, and the display surface 11c appears outside.

It is noted that the display 11 is not limited to the liquid crystal panel, and other display elements such as an organic EL, etc., can be used.

The touch sensor 12 is placed on the display surface 11c, and detects an input position with respect to the display surface 11c. The touch sensor 12 is formed to be a transparent sheet shape, and a user can see the display surface 11c through the touch sensor 12.

The touch sensor 12 is a capacitance touch sensor and provides a first transparent electrode and a second transparent electrode, which are arranged in a matrix state, and a cover. The touch sensor 12 detects a position on the display surface 11c where the user touches as an input position by detecting changes in capacitance between the first and the second transparent electrodes and outputs a positional signal according to its input position to a later explained CPU 100. It is noted that touching on the display surface 11c means, in fact, that touching the area corresponding to the display surface 11c on the surface of a caver overlapping the touch sensor 12.

The user can perform a wide variety of operations such as a tap, a slide, a flick, a long tap, etc., by touching the display surface 11c with a user's own finger or a contact member such as a pen and so on (for simplification, hereinafter, simply refer to a “finger”).

It is noted that the touch sensor 12 is not limited to the capacitance touch sensor 12, but it can be the touch sensor 12 of an ultrasonic, a pressure-sensitive, a resistance film or a photodetecting type, etc.

A key operation part 13 composed of a home key 13a, a setting key 13b and a back key 13c is provided at a lower part of the touch panel. The home key 13a is the key for displaying mainly the home screen on the display surface 11c. The setting key 13b is the key for displaying mainly a setting screen to perform various settings on the display surface 11c. The back key 13c is the key for restoring mainly the display state of the screen on the display surface 11c to the state of one step prior.

On the front surface side of the cabinet 10, a microphone 14 is arranged at the bottom part, and the speaker 15 is arranged at the top part. By receiving a voice from the speaker 15 by the ear and by letting out a voice to the microphone 14, the user can have a phone conversation.

FIG. 2 is a block diagram showing an overall configuration of the cellular phone 1. The cellular phone 1 includes a CPU 100, a memory 101, an image processing circuit 102, a key input circuit 103, a voice encoder 104, a voice decoder 105 and a communication module 107 other than the above mentioned components.

The image processing circuit 102 generates an image displayed on the display 11 according to a control signal input from the CPU 100, and stores image data in a VRAM 102a provided on the image processing circuit 102.

The image processing circuit 102 includes a LCD controller. The LCD controller outputs an image signal including the image data stored in the VRAM 102a to the display 11. Also, the LCD controller outputs a control signal for controlling the display 11. According to this, the panel backlight 11b of the display 11 is turned on or turned off. As such, light emitted from the panel backlight 11b is modulated by the liquid crystal panel 11a based on the image signal, an image is displayed on the display surface 11c of the display 11.

The key input circuit 103 outputs signals according to pressing down of each key 13a-13c composing the key operation module 13 to the CPU 100.

The voice encoder 104 converts a voice signal output by the microphone 14 according to the voice gathered into a digital voice signal and outputs the digital voice signal to the CPU 100.

The voice decoder 105 performs decoding processing and D/A conversion on the voice signal from the CPU 100, and outputs the converted analog voice signal to the speaker 15.

The communication module 107 includes an antenna for transmitting and receiving radio waves for telephone calls and correspondences. The communication module 107 converts signals input from the CPU 100 into radio signals, and transmits the converted radio signals to a communication destination of a base station, other communication device, etc., through the antenna. Also, the communication module 107 converts the radio signals received through the antenna into signals of forms that the CPU 100 can use, and outputs the converted signals to the CPU 100.

The memory 101 includes ROM and RAM. The memory 101 stores a control program for granting the CPU 100 a controlling function and a wide variety of applications. For example, the memory 101 stores a wide variety of applications such as a telephone call, an E-mail, a text messaging, web browser, etc.

Also, the memory 101 is used as a working memory to store a wide variety of data temporality used or generated when an application is executed.

The CPU 100 executes a wide variety of applications by controlling each component such as the microphone 14, the communication module 107, the display 11, the speaker 15, and so on, according to the control program.

The above “text messaging” is an application to send and receive text messages between the cellular phone 1 and other communication devices, such as other cellular phones, etc. In concrete, the text messaging is an application for sending and receiving a message of a short sentence with other communication devices using the SMS.

The text messaging is activated based on a predetermined operation to be performed. When the operation for specifying another communication device is done by the user, the CPU 100 sets the specified communication device as a communication terminal to send and receive messages.

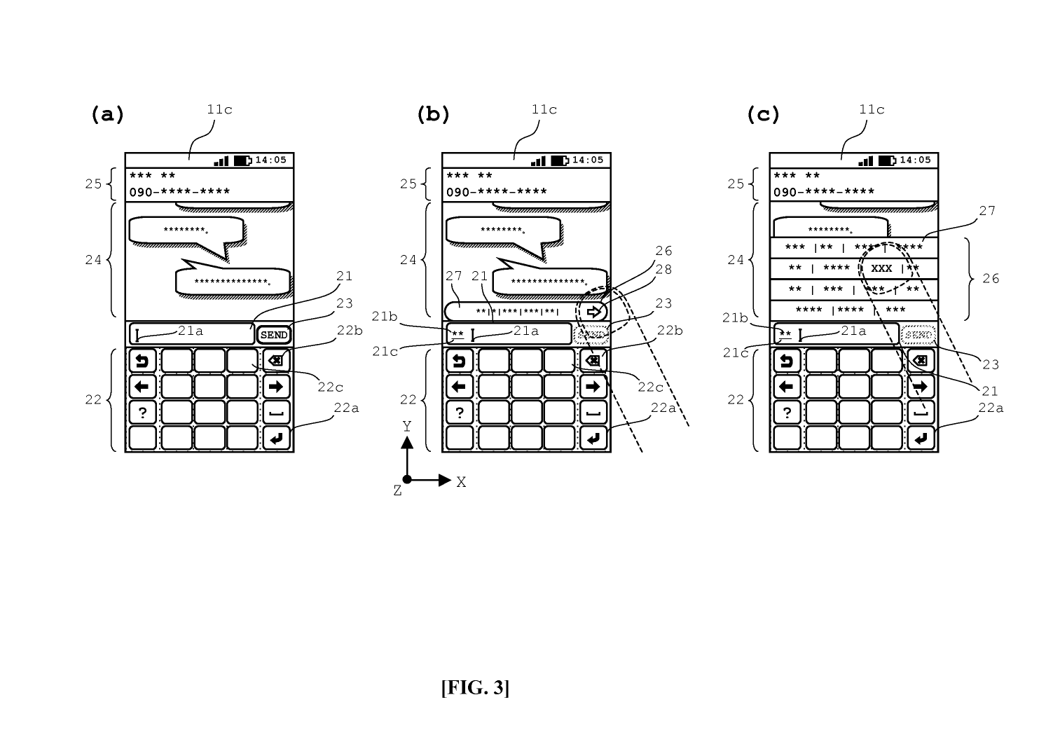

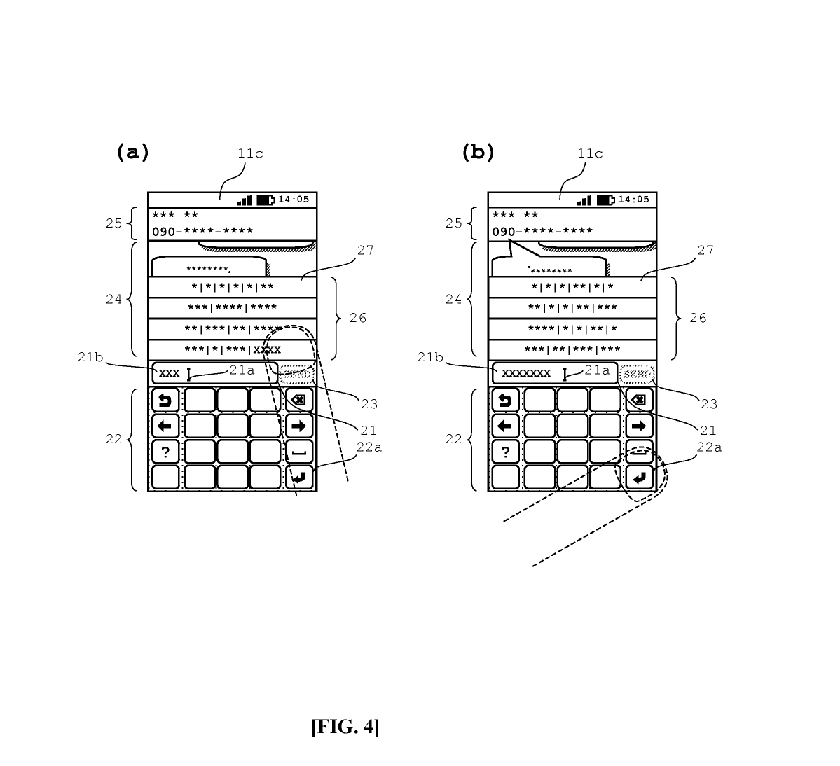

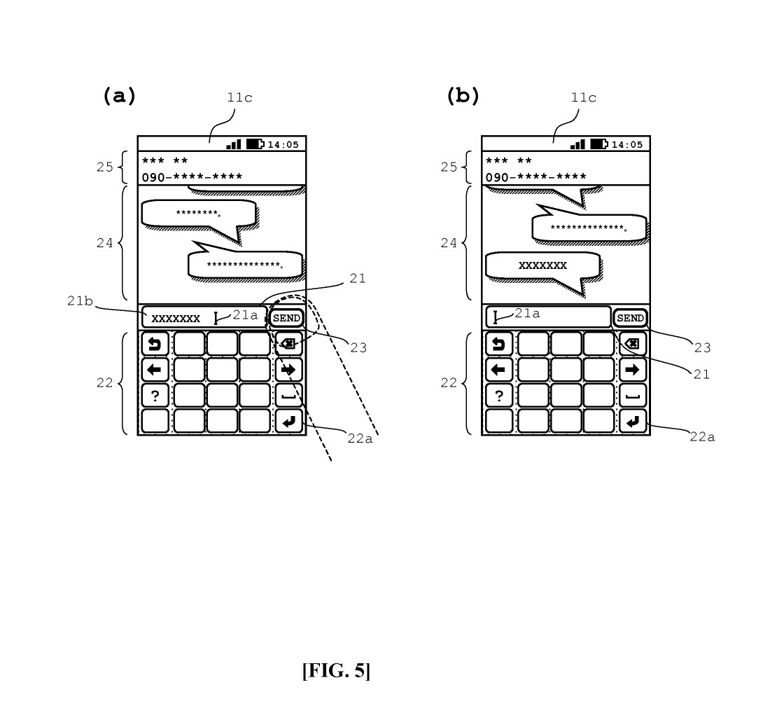

FIGS. 3(a)-(c), FIGS. 4(a), (b), FIGS. 5(a) and (b) are diagrams showing transition examples of screens displayed on the display surface 11c when the text messaging is executed. FIG. 3(a) is a diagram showing a screen displayed on the display 11 when an acceptance of an input for composing a text to be sent as a message is started. FIG. 3(b) is a diagram showing a screen of a state that the text 21b consists of undetermined characters (later discussed) is input in the text box 21.

Referring to FIG. 3(a), on the display surface 11c, images of a text box 21, a keyboard 22, a send button 23 and a message display area 24 are displayed. When inputs with respect to the images of the keyboard 22 and the send button 23 are performed, the CPU 100 obtains the inputs as the inputs matched with the images the inputs being performed.

The text box 21 is a portion for displaying the text created by the user. In a state of FIG. 3(a), no text is displayed in the text box 21, and a cursor 21a for showing the input position of a character is displayed. In the state of FIG. 3 (b), in the text box 21, a text 21b consists of undetermined characters “ima” and a cursor 21a are displayed.

The key board 22 is configured with a plurality of soft keys, and displayed almost adjacent to the bottom side (Y axis negative direction) of the text box 21. According to the input (a touch input for each key) with respect to the keyboard 22, inputting and deleting of characters, moving the cursor, setting of types of inputting characters (alphabetical characters, numbers, signs, Japanese characters, characters used in other countries, pictographs, etc.) will be performed.

The keyboard 22 displayed on the display surface 11c in examples shown in FIGS. 3-5 is a keyboard for inputting Japanese characters. It is noted that when an operation to change the setting of inputting character types, the CPU 100 displays the keyboard 22 of a corresponding mode for the set character type (for example, the QWERTY keyboard), instead of the keyboard 22 for inputting the Japanese characters.

The send button 23 is displayed almost adjacent to the right side of the text box 21 (X axis positive direction). The keyboard 22 is almost adjacent to the bottom side of the send button 23. The send button 23 is the button for sending the text 21b displayed on the text box 21 to other communication devices as a message.

When the send button 23 is pressed down (the position of the send button 23 is tapped), the CPU 100 executes sending the message.

The message display area 24 is provided on the upper side of the text box 21. Messages sent and received in the past are displayed on the message display area 24.

It is noted that on the further upper side of the message display area 24, an information display area 25 for displaying information related to other communication devices which are destinations of the messages is provided.

An operation for creating the text 21b and transitions of screens associated with the operation are outlined below.

By the input with respect to the keyboard 22, new characters are inserted and displayed at the position of the cursor 21a in the text box 21. The newly displayed characters are first viewed as undetermined characters. For instance, as shown in FIG. 3(b), when new characters are inserted, the text 21b displayed on the text box 21 is viewed as the undetermined characters.

Here, the “undetermined” means a state before changed to other character forms. Or, the “undetermined” means, when an operation for determining (later explained) is performed without changing the characters to the other character forms, the state before the operation for determining is done. It is noted that changing means for changing the undetermined characters to other characters of words, segments, etc. suggested by the proposing processing. Also, the changing can include the kana-kanji conversion, supplement of the undetermined characters being input, changes of incorrectly-inputted characters with the correct characters, etc.

It is noted that the CPU 100 put underline 21c under the undetermined characters in the text 21b displayed on the text box 21 as shown in FIG. 3(b).

The CPU 100 executes a predicting processing and proposing processing for aiding a composition of text by the user when undetermined characters are newly inserted to the text 21b. As described later, the execution of the predicting processing and the proposing processing is terminated when the operation for deciding is performed.

Here, the operation for determining means (for example, the operation for pressing down the key 22a) the operation by which the undetermined characters included in the text 21b are transitioned to determined characters as undetermined characters are without being changed to other characters, and the predicting processing and the proposing processing are terminated. It is noted that by being changed the undetermined characters into the other characters, when the text 21b does not include the undetermined characters, the operation for determining is only the operation for terminating the predicting processing and the proposing processing.

The predicting processing is a processing for specifying one or more candidates by predicting a word, a clause, etc., which the user is currently inputting based on the text 21b. In concrete, the predicting processing is a processing for predicting words, clauses, etc., that can be replaced with the undetermined characters when the text 21b includes one or more characters of undetermined characters, and a processing for predicting words, clauses, etc., that can be inserted in a position of the cursor 21a in the text 21b when the text 21b does not include undetermined characters since the undetermined characters are being changed to other characters.

It is noted that when the text 21b is repeatedly updated by inserting undetermined characters, etc., words, clause, etc., to be candidates (hereinafter, referred to as “predicted words”) are updated as needed based on the text 21b at that time by executing the predicting processing by the CPU 100.

The proposing processing is a processing that proposes a user predicted words 27 (displaying the proposing window 26), and accepts the operation for selecting one of the predicted words 27. When one predicted word 27 is selected, the undetermined characters are changed to the selected predicted word 27, and the characters after the change are made become determined characters.

The CPU 100 displays the proposing window 26 according to the proposing processing, as shown in FIG. 3 (b), to be almost adjacent to the upper side of the text box 21 and the send button 23, and to be overlapped with the message display area 24. Further, the CPU 100 displays a part or all of the predicted words 27 on the proposed window 26 as changing candidates for changing the undetermined characters. The proposing window 26 is hidden according to the termination of the proposing processing.

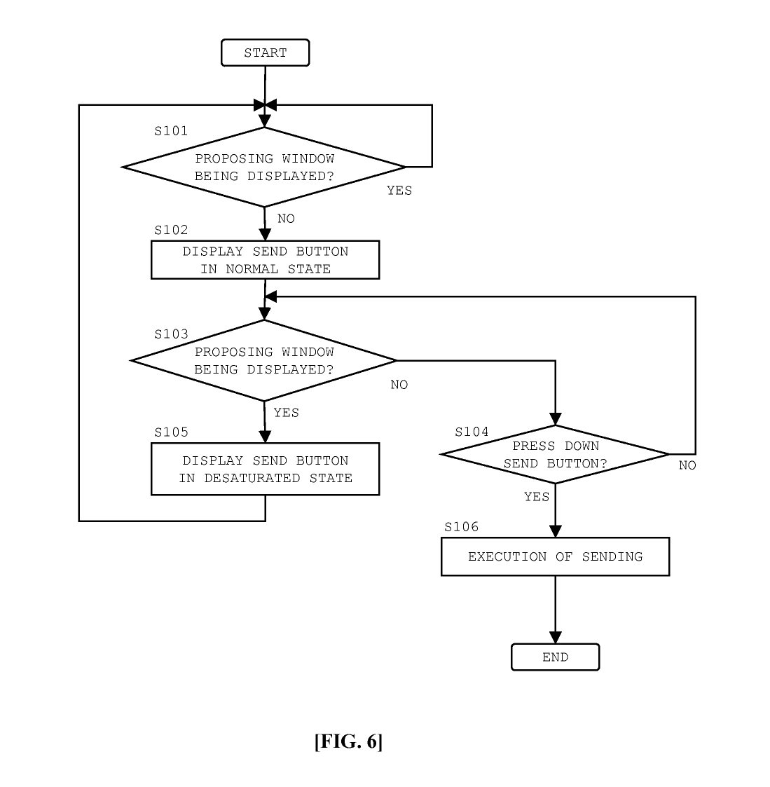

It is noted that, in FIG. 3(b), the send button 23 is displayed with different saturation with the saturation of the send button 23 in FIG. 3(a), and is invalidated. The invalidation and the display state by different saturation of the send button 23 continue while the proposing window 26 is displayed. That is, the CPU 100 executes the control to suppress sending messages while the proposing window 26 is displayed. When the proposing processing is terminated, the send button 23 is again validated, and the display state of the send button 23 is returned to the normal state (see FIG. 5(a)). Such operation with respect to the send button 23 and processing related to the display of the send button 23 are later described in details using the flow chart of FIG. 6.

Returning to FIG. 3(b), a plurality of predicted words 27 is displayed abreast on the proposed window 26. On the further right side, a switching button 28 for switching the display aspects of the proposing window 26 is displayed.

The switching button 28 is a button for displaying the proposing window 26 bigger. The predicted words 27 can be more than one, so all the predicted words 27 cannot always be displayed on the proposing window 26. By pressing down the switching button 28, the display aspect of the proposing window 26 is switched as in FIG. 3(c), and more predicted words 27 are displayed on the proposing window 26 in addition to the predicted words 27 displayed on the proposing window 26 in FIG. 3(b).

The user presses down the switching button 28 to switch the proposing window 26 to be a bigger state shown in FIG. 3(c) when there is no desired predicted word 27 on the proposing window 26 in a small state shown in FIG. 3(b).

In a state that the proposing window 26 is displayed, the CPU 100 accepts the operation for selecting one of the displayed predicted words 27 according to the proposing processing.

For example, as in FIG. 3(c), in a state the proposing window 26 is displayed, when the operation to select one predicted word 27 (for instance, the operation for tapping on the targeted predicted word 27) is performed, as shown in FIG. 4(a), the undetermined characters are changed to the determined characters.

The predicting processing and the proposing processing are continued to be executed after the undetermined characters are changed to the determined characters as the above. That is, the predicting processing and the proposing processing can be executed not only before the undetermined characters are determined, but also after the undetermined characters are determined.

For example, when an example is a transition of screens from a screen of FIG. 3(c) to a screen of FIG. 4(a), the CPU 100 predicts words, clauses, etc., to be further inserted in the position of the cursor 21a in FIG. 4(a) according to the predicting processing and displays a part or all of the predicted words 27 on the proposing window 26 as the input candidates for inputting at the position of the cursor 21a as shown in FIG. 4(a) according to the proposing processing.

It is noted that as shown above, a configuration to terminate the predicting processing and the proposing processing after the undetermined characters are changed to the determined characters can be employed.

In the display state of FIG. 4(a), for example, when one predicted word 27 shown on the bottom right corner of the proposing window 26 is selected, the CPU 100 inserts the determined characters in the position of the cursor 21a. For this reason, as shown in FIG. 4(b), the text 21b consisting of the determined characters is displayed in the text box 21.

While the proposing processing is executed, the CPU 100 accepts the operation for determining as described above (for instance, the operation for pressing down the key 22a).

For example, in the state of FIG. 4(b), when the operation for determining is performed, the predicting processing and the proposing processing are terminated. It is noted that after the termination of the proposing processing, the CPU 100 makes the display state of the send button 23 back to before as described above, and validates the send button 23 which has been invalidated. For this reason, after this, the operation with respect to the send button 23 by the user is accepted. As a result, as shown in FIG. 5(a), the display of the proposing window 26 is turned off. Also, the send button 23 is displayed with the normal saturation (later described. S102 of FIG. 6).

In the display state of FIG. 5(a), when the send button 23 is pressed down (see the finger drawn with the dashed line), the CPU 100 sends the text 21b displayed on the test box 21 as a message of the text messaging to other communication devices. Also, the CPU 100 displays the message after sent on the message display area 24 as shown in FIG. 5(b), resets the text 21b to be an empty state, and displays the text box 21 of the empty state according to this on the display surface 11c.

As such, the creation of the text 21b and the processing for sending the message are executed.

As above, the user can finish creating the desired text 21b by performing the input with respect to the keyboard 22 and the proposing window 26 which are images for inputting characters when creating the text 21b, and can send the finished text 21b as the message to other communication devices.

However, there might be a possibility of sending unfinished text 21b with an operation performed by a user unintentionally.

For instance, as explained in FIG. 3(b), the user can touch the display surface 11c intended to press down the switching button 28 (see the finger drawn with the dashed line). However, there is a possibility of sending the unfinished text 21b as the message by pressing down the send button 23 arranged almost adjacent to the bottom side of the switching button 28 by mistake.

Also, as explained in FIG. 4(a), the user can touch the display surface 11c intending to select one predicted word 27 displayed on the proposing window 26 (see the finger drawn with the dashed line). However, there is a possibility of sending the unfinished text 21b as the message by pressing down the send button 23 arranged almost adjacent to the bottom side of the area where the predicted word 27 is displayed by mistake.

Then, the cellular phone 1 has a function to suppress sending the unfinished text 21b as the message.

FIG. 6 is a flow chart for showing a processing for suppressing sending a message and displaying a sending button 23 with different saturation while a text 21b is in the middle of being input for creation.

The processing of FIG. 6 is started when an empty text box 21 shown in FIG. 3(a) is displayed on the display surface 11c during the execution of a text messaging and terminated after the created text 21b is sent.

It is noted that a determination whether it is in the middle of inputting for creating the text 21b or not is done according to whether a proposing window 26 is being displayed or not.

The CPU 100 displays the send button 23 in the normal state (S102) when the proposing processing is not being executed as in FIG. 3(a) or the proposing window 26 is not being displayed (S101: NO). Then, while the proposing processing is not executed and the send button 23 is not pressed down (S103: NO, S104: NO), the display of the send button 23 in the normal state is kept.

It is noted that while the proposing processing is not executed (S103: NO), the operation with respect to the send button 23 is accepted (S104). Thus, when the send button 23 is pressed down (S104: YES), the text 21b is sent to other communication devices as the message (S106).

As in an example of FIG. 3(b), when characters are newly input, the predicting processing and the proposing processing are executed, and because of this, the proposing window 26 is displayed on the display surface 11c. For this reason, the CPU 100 determines that the proposing processing is being executed in the step S103 (S103: YES), and displays the send button 23 with different saturation than usual, for instance, in a desaturated state compared to a normal state (S105).

While the proposing processing is being executed (S101: YES), the display of the send button 23 in the desaturated state is kept. For example, in FIGS. 3(b)-4(b), the proposing window 26 is displayed on the display surface 11c. For this reason, in the determination processing of the step S101, it is determined YES, and the send button 23 is displayed in the desaturated state.

The operation with respect to the send button 23 is accepted (S104) while the proposing processing is not executed (S103: NO). However, the operation with respect to the send button 23 is not accepted while the proposing processing is executed (S101: YES). That is, the send button 23 is invalidated.

In sum, when the proposing processing is being executed (S101), it is considered to be in the middle of inputting for creating a message, therefore it is suppressed to send the message. For this reason, while in a state that screens of FIGS. 3(b)-4(b) are displayed, an input with respect to the send button 23 is not accepted, and sending the message is suppressed. Thus, even if the send button 23 is mistakenly pressed down, the unfinished text 21b would not be sent as a message.

In contrast, for example, in a state of FIG. 5(a) that the proposing processing is not executed, since it is determined that it is not in the middle of inputting for creating the text 21b (S103: NO), when the send button 23 is pressed down (S104: YES), the current text 21b is sent as a message.

According to the configuration of the present embodiment, while the characters for creating the text 21b are input, the send button 23 is invalidated. For this reason, sending the unfinished text 21b as a message to other communication devices is suppressed.

Also, when it is determined to be in the middle of inputting characters since the proposing window 26 is displayed (S103: YES), a saturation of the send button 23 is decreased than usual. For this, the user can input with respect to the keyboard 22 which is an image for inputting characters and the proposing window 26 while the user is aware that the send button 23 is currently invalidated.

Also, in the present embodiment, it is determined whether it is in the middle of inputting the characters or not based on whether the proposing window 26 is displayed or not. While an input with respect to the proposing window 26 is accepted (S103: YES), there is a possibility of characters to be further added (input) to the text 21b. Thus, in this case, it is considered to be in the middle of inputting the characters, and even if the send button 23 is pressed down, the message would not be sent.

For instance, referring to FIG. 3(b), on the lower side of the send button 23, a delete key 22b and keys 22c for inputting characters are displayed as a part of the image of the keyboard 22. In addition, on the upper side of the send button 23, other than the switching button 28, a part of the predicted words 27 are displayed almost adjacent to the send button 23. When it is determined to be in the middle of inputting characters based on the processing of FIG. 6, even if these keys 22b, 22c and the predicted words 27 are pressed down, sending the message is suppressed.

### Modification Example 1

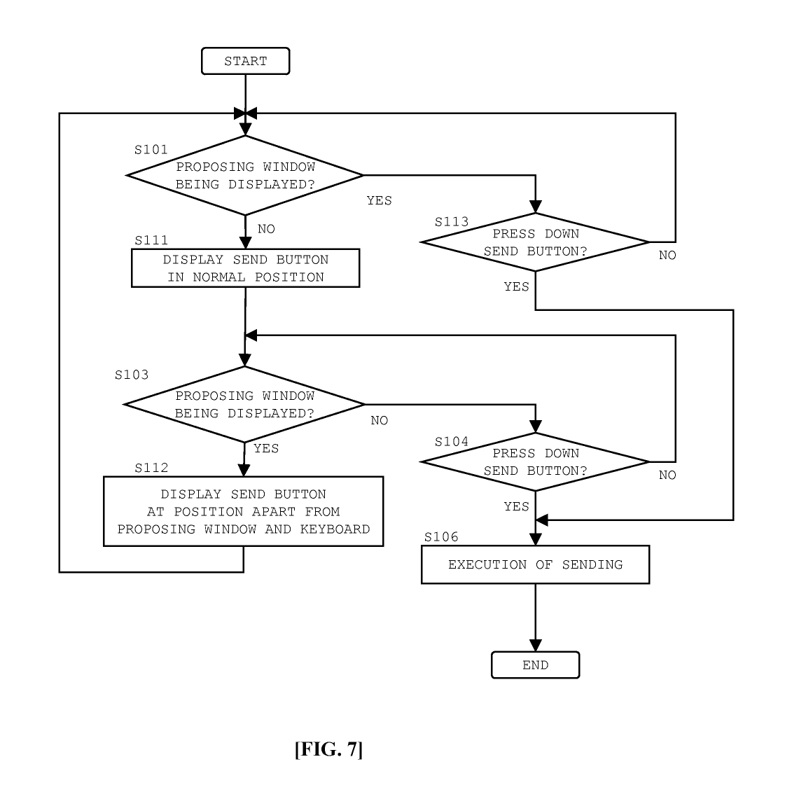

FIG. 7 is a flow chart for showing a processing for suppressing sending a message while an input for creating the text 21b is being performed according to a modification example 1.

The flow chart of FIG. 7 is a flow chart that replaces the processing of the step S102 with the step S201 and the processing of the step S105 with the step of S112, and further adds the processing of the step S113 which is executed when it is determined to be YES at the step S101 compared with the flow chart of FIG. 6.

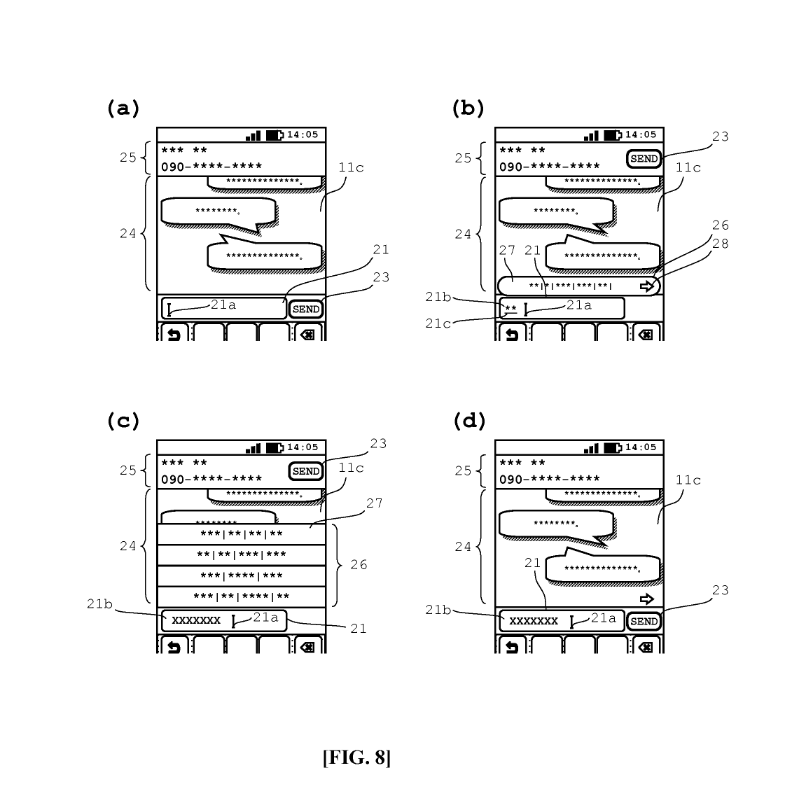

FIGS. 8(a)-8(d) are diagrams showing transition examples of screens displayed on the display surface 11c when the text messaging is executed according to the present modification example. FIGS. 8(a)-8(d) correspond to FIGS. 3(a), 3(b), 4(b) and 5(a) explained in the above embodiment, respectively. It is noted that in FIGS. 8(a)-8(d), a part of display of keyboard 22 is omitted.

In the step S111, the CPU 100 displays the send button 23 at a normal position. The normal position means the same display position of the send button 23 in the above embodiment that is next to the text box 21 on the right side (see FIG. 3(a)).

Right after the text box 21 is displayed, as shown in FIG. 8(a), the proposing processing is not executed (S101: YES), so the send button 23 is displayed in the normal position (S111).

The proposing processing is executed by inputting undetermined characters in the text box 21, and the proposing window 26 is displayed (S103: YES), in the step S112, the CPU 100 displays the send button 23 in a position away from the proposing window 26 and the keyboard 22. In concrete, the send button 23 is moved and displayed at the right side part of the information display area 25 as shown in FIGS. 8(b) and 8(c). While the proposing processing is executed (S103: YES), the display position of the send button 23 is kept.

In a state of FIG. 8(c), an operation for determining is performed (pressing down the key 22a), the proposing processing is terminated (S101: NO), and as shown in FIG. 8(d), the send button 23 is returned to the normal position and displayed (S111).

In the present modification example, as in FIGS. 8 (b) and 8(c), even when the proposing processing is executed (S101: YES), the CPU 100 accepts pressing down of the send button 23 (S113). When the send button 23 is pressed down (S113: YES), the CPU 100 sends the text 21b displayed in the text box 21 as a message to other communication devices (S106).

According to the configuration of the present modification example, in the middle of inputting the characters for creating the text 21b, that is, when the proposing window 26 is displayed on the display surface 11c, the send button 23, the key board 22 which is the image for inputting the characters and the proposing window 26 are displayed apart compared to when it is not in the middle of inputting the characters for composing the text 21b. In concrete, the send button 23 is moved to be apart from the keyboard 22 and the proposing window 26.

For this reason, it is suppressed for the send button 23 to be pressed down by mistake when an input with respect to the keyboard 22 which is the image for inputting characters and the proposing window 26 is performed.

Also, while in the above embodiment, the send button 23 is invalidated during the input of characters, in this modification example, the send button 23 is not invalidated. That is, in the present modification example, sending the message is not suppressed by making the send key 23 invalidated, but suppressed for being displayed on a position where the send key 23 is hard to be pressed down.

Thus, according to the configuration of the present modification example, even when it is in the middle of inputting the characters, the send button 23 is validated. For this reason, even when it is determined to be in the middle of inputting the characters by the CPU, when the user wishes, the text 21b can be sent to other communication devices as a message by pressing down the send button 23. Therefore, sending of the unfinished message is suppressed, and at the same time, the user can send the message easily if needed.

### Modification Example 2

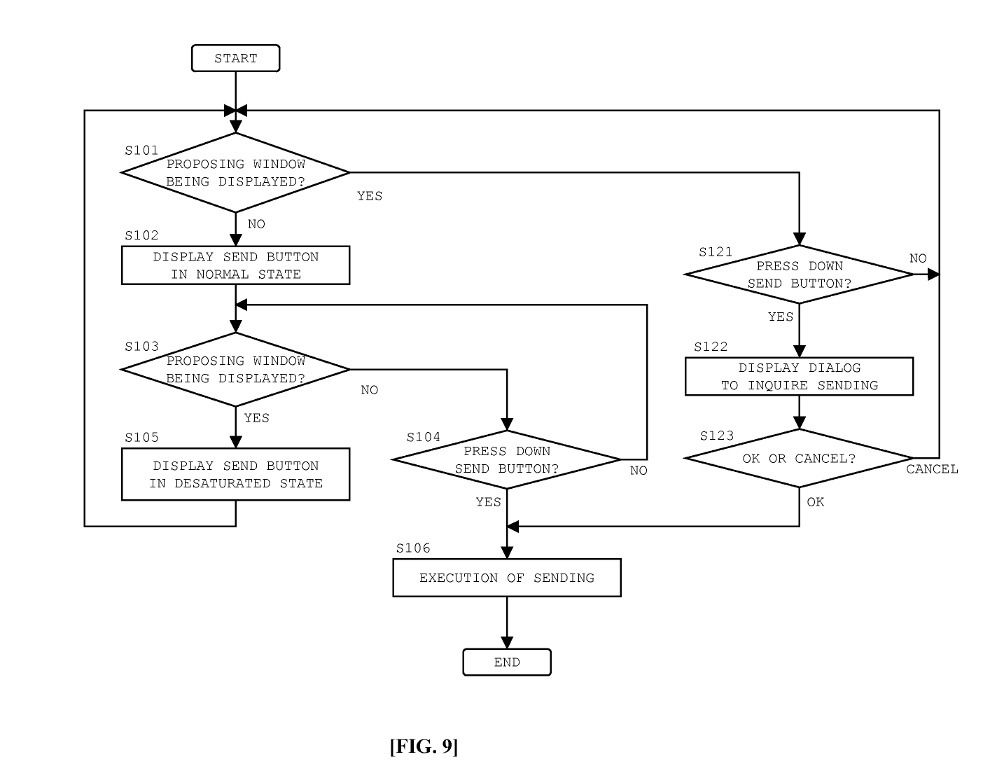

FIG. 9 is a flow chart showing the processing for suppressing the sending of the message while inputting the characters for creating the text 21b according to a modification example 2.

The flow chart of FIG. 9 is a flow chart that adds the processing of the steps S121-S123 executed when it is determined to be YES at the step S101 compared with the flow chart of FIG. 6.

In the above modification, if it is determined to be in the middle of an input for creating the text 21b, that is, when the proposing window 26 is displayed on the display surface 11c, the send button 23 is invalidated. In contrast, in the present modification example, even when it is determined to be in the middle of the input for creating the text 21b, the send button 23 is validated, and according to the pressing down of the send button 23, a processing for inquiring the user about sending the message is executed.

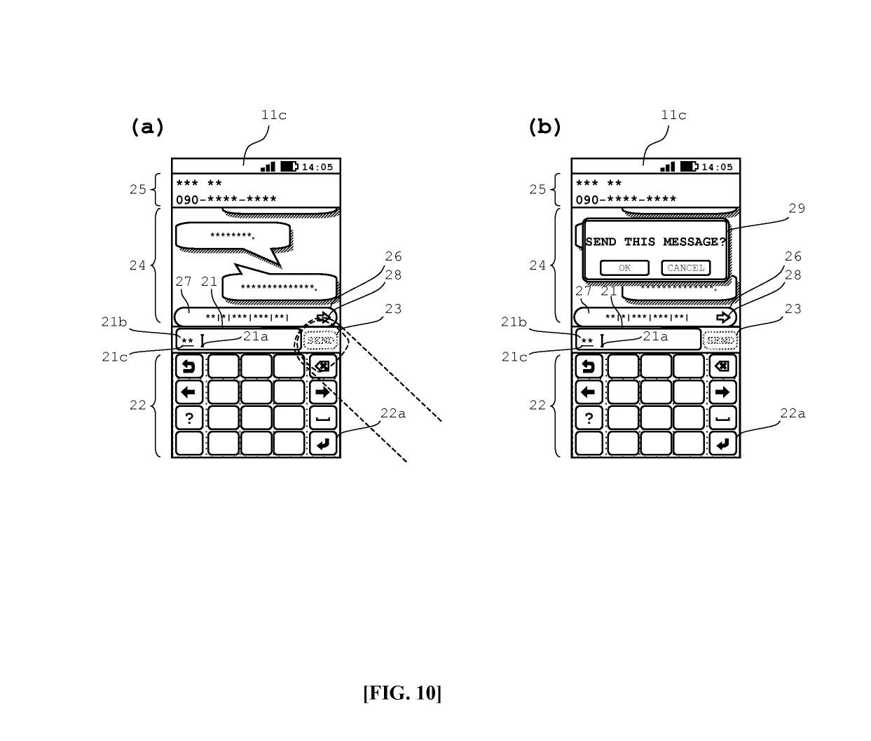

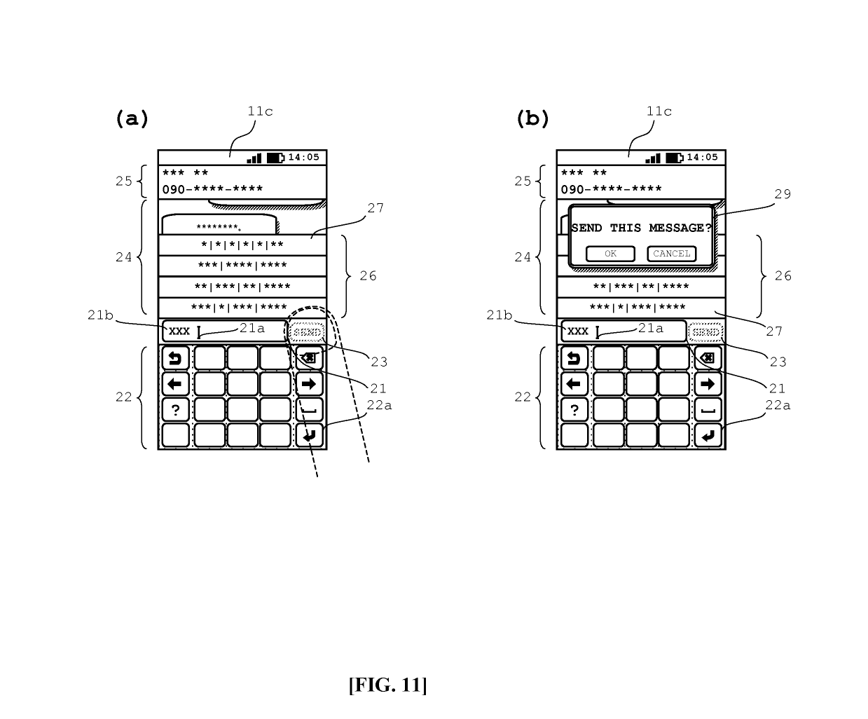

FIGS. 10(a), (b), FIG. 11(a) and (b) are diagrams showing examples of the screens displayed when the send button 23 is pressed down while the input for creating the text 21b is performed. FIGS. 10(a) and 11(a) correspond to FIG. 3(b) and FIG. 4(b) explained in the above embodiment. FIGS. 10(b) and 11(b) are diagrams showing the screens when the processing of inquiring about sending the message is executed according to the operation of the send button 23 in the states of FIGS. 10(a) and 11(a), respectively.

When the proposing processing is executed, the saturation of the send button 23 is decreased (S105), and the proposing window 26 is displayed (S101: YES), in the step S121, the CPU 100 determines whether the send button 23 is pressed down or not (S121).

When the send button 23 is pressed down (S121: YES), for example, when the send button 23 is pressed down in the state shown in FIG. 10(a), the CPU 100 displays a dialog box (hereinafter, referred to as a “dialog”) 25 inquiring whether the text 21b composed of currently undetermined characters to be sent as a message to other communication devices or not on the display surface 11c. On the dialog 29, a button to allow (OK) sending and a button to cancel (CANCEL) are displayed.

When the operation to allow sending is performed (S123: YES), the message is sent (S106). In this case, the text 21b composed of undetermined characters is sent as a message to other communication devices.

When the operation to cancel sending is performed (S123: CANCEL), the processing returns to the step S101.

It is noted that in the present modification example, the dialog 29 is displayed despite the text 21b includes undetermined characters or not when the send button 23 is pressed down. For instance, as shown in FIG. 11(a), even when the text 21b composed of determined characters is displayed on the text box 21, if the proposing window 26 is displayed, when the send button 23 is pressed down (S121: YES), as shown in FIG. 11(b), the dialog 29 is displayed.

When the operation to allow sending is performed (S123: YES), the message is sent (S106). In this case, the text 21b consists of determined characters is sent as a message to other communication devices.

When the operation to cancel sending is performed (S123: CANCEL), the processing returns to the step S101.

It is noted that in a state that the dialog 29 is displayed on the display surface 11c as in FIGS. 10(b) and 11(b), when the operation to cancel sending the message is performed, the screen displayed on the display surface 11c and the text 21b are returned to the state before the dialog 29 is displayed, and the input with respect to the proposing window 26 is again accepted. The user can continue to operate inputting the characters without inputting the inputted characters again before the dialog 29 is displayed.

According to the configuration of the present modification example, while the characters are input for creating the text 21b, that is, when the proposing window 26 is displayed on the display surface 11c, if the input with respect to the send button 23 is performed, the inquiry about an advisability for sending the message is performed. The user can select whether to allow (OK) sending the text 21b as a message to other communication devices or not (CANCEL) after seeing the dialog 29. The user can choose not to send the message if the pressing down of the send button 23 is not based on the user's intention, and the user can choose to send the message if the pressing down the send button 23 is based on the user' intention.

### Modification Example 3

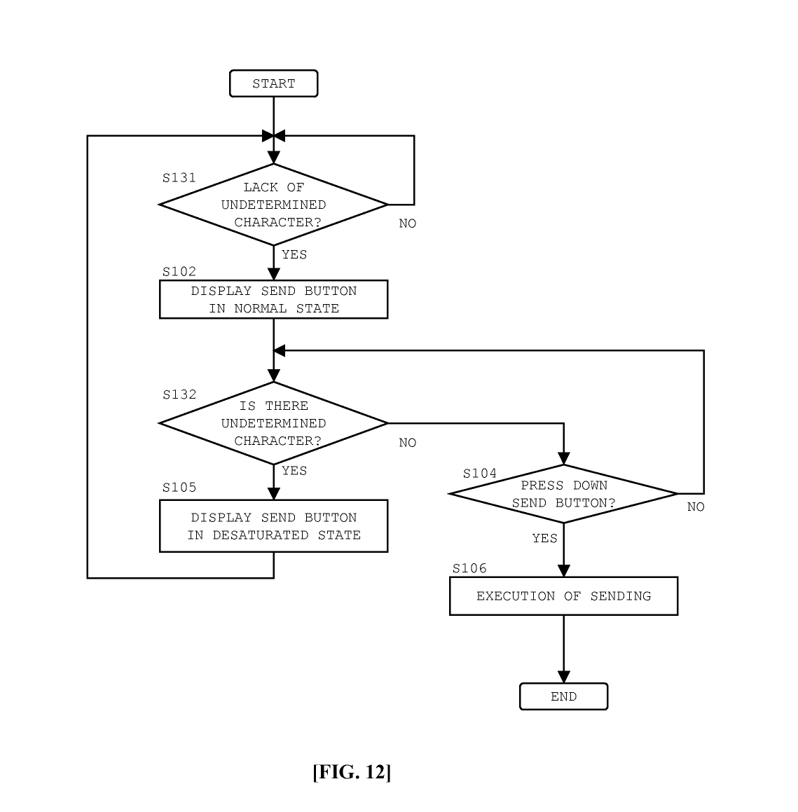

FIG. 12 is a flow chart displaying the processing for suppressing sending a message while inputting characters for creating the text 21b according to the modification example 3.

In the above embodiment, whether it is in the middle of inputting the characters or not is determined based on presence or absence of the display of the proposing window 26. On the other hand, in the present modification, whether it is in the middle of input of characters or not is determined based on whether the text 21b includes undetermined characters or not.

The flow chart of FIG. 12 is a flow chart that replaces the processing of the step S101 with the step S401 and the processing of the step S103 with the step S132 compared with the flow chart of FIG. 6.

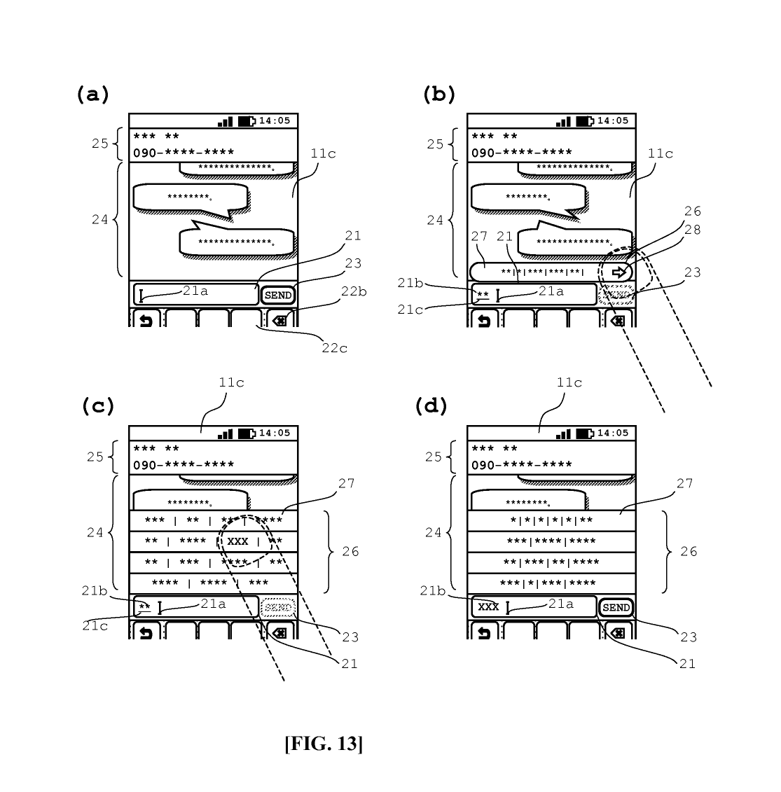

FIGS. 13(a) to 13(d) are diagrams showing transition examples of the screens displayed on the display surface 11c when the text messaging is executed according to the present modification example. FIGS. 13(a) to 13(d) correspond to the FIGS. 3(a), (b), FIGS. 4(a) and (b) explained in the above embodiment, respectively.

In the step S131, the CPU 100 determines whether the text 21b includes the undetermined characters or not. When the text 21b does not include the undetermined characters (S131: YES), the processing is progressing to the step S102.

In the step S 132, the CPU 100 determines whether the text 21b includes the undetermined characters or not. When the text 21b includes the undetermined characters (S132: YES), the processing is progressing to the step S105, and when the text 21b does not include the undetermined characters (S131: NO), the processing is progressing to the step S104.

As shown in FIG. 13(a), in a state where the text 21b does not include undetermined characters (S132: NO), if the undetermined characters are newly input as in the FIG. 13(b) (S132: YES), the send button 23 is displayed with a desaturated state (S105).

Also, in a state where the text 21b includes the undetermined characters as shown in FIG. 13(c) (S131: NO), in the proposing window 26, one predicted word 27 can be selected (see the finger drawn with a dashed line). In this case, as stated above, the undetermined characters are converted to the determined characters as shown in FIG. 13(d). In this case, the proposing window 26 is still displayed on the display surface 11c, based on the determination that there are no undetermined characters at the determination processing 5131 (S131: YES), the send button 23 is displayed in a normal state (S102).

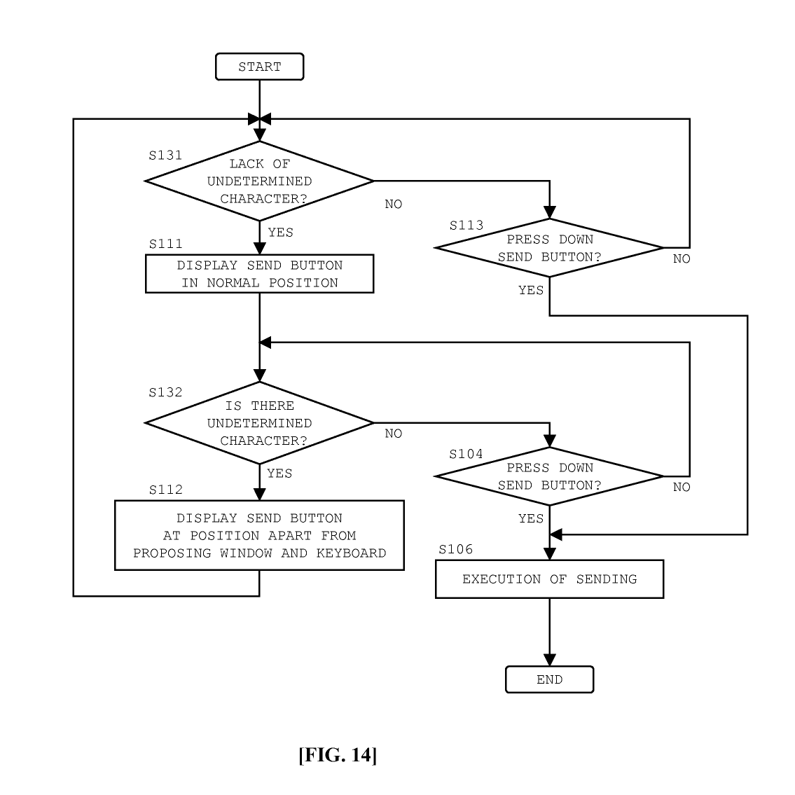

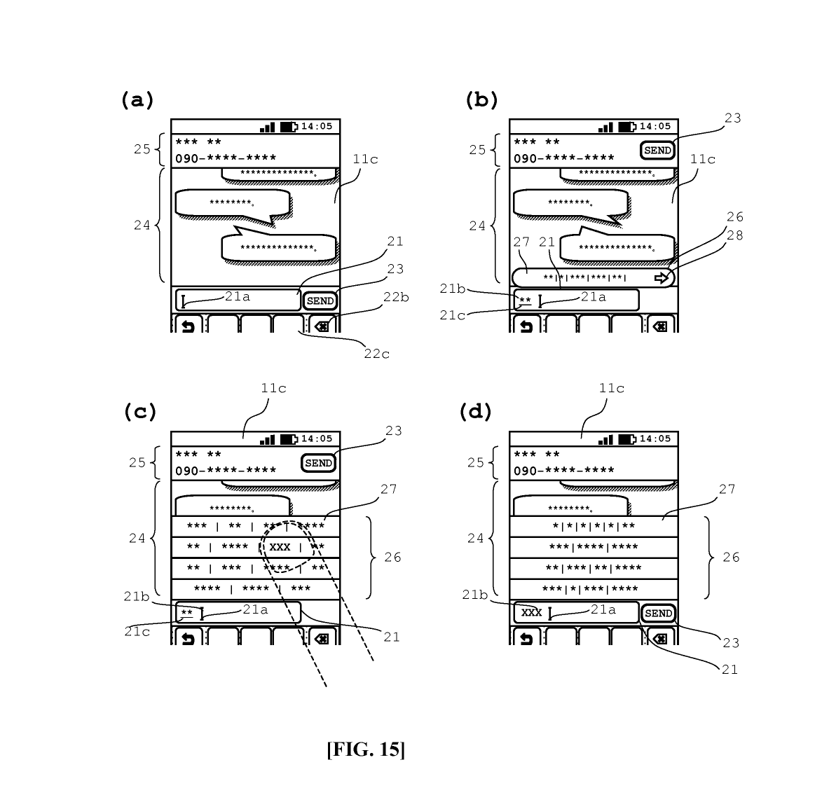

Also, for example, as in FIG. 15(b), in a state the text 21b includes the undetermined characters, when the user inputs with respect to the key 22b or 22c, if the user press down the send button 23 adjacent to the key 22b or 22c by mistake, based on the processing of the step S131 of FIG. 14, the processing does not progress to the next step S102. That is, while the text 21b includes the undetermined characters, the send button is invalidated, so sending the unfinished message is suppressed.

According to the configuration of the present modification example, different from the above embodiment, whether it is in the middle of inputting characters for creating text 21b or not is determined based on whether the current text 21b includes the undetermined characters or not. Because of this, the CPU 100 determines whether it is in the middle of inputting the characters or not based on whether the user is actually inputting the characters or not.

For this reason, whether the user is in the middle of inputting the characters or not is determined more accurately, and when the user is actually in the middle of inputting the characters, sending the message is suppressed.

On the other hand, while the user is not actually inputting the characters, a processing of an aspect not to suppress sending with the send button 23 (S132 and S104) is executed, and sending a message at this time becomes easy.

### Modification Example 4

The above embodiment and the modification examples 1-3 can be combined to each other. For example, as explained below, a configuration of combining the modification example 1 and the modification example 3 is possible.

FIG. 14 is a flow chart showing the processing for suppressing sending a message while in the middle of inputting for creating the text 21b according to the modification example 4.

In the present modification example, according to whether it is in the middle of inputting for creating the text 21b or not, the send button 23 is moved as the same with the modification example 1. Also, in the present modification example, the determination of whether it is in the middle of inputting for creating the text 21b or not is done based on whether the text 21b includes the undetermined characters or not as the same with the modification example 3.

The flow chart of FIG. 14 is a flow chart that replaces the processing of the step S101 with the step S131 and the processing of the step S103 with the step S132 compared with the flow chart of FIG. 7 (the modification example 1).

FIGS. 15(a) to 15(d) are diagrams showing transition examples of screens displayed on the display surface 11c at the time of executing the text messaging according to the present modification example. FIGS. 15(a) to 15(d) correspond to FIGS. 13(a) to 13(d) explained in the modification example 3, respectively.

As shown in FIG. 15(a), in a state where the text 21b does not include undetermined characters (S131: YES), if the undetermined characters are newly input as in the FIG. 15(b) (S132: YES), the send button 23 is moved to a right side part of the information display area 25 (5111).

Also, in a state where the text 21b includes the undetermined characters as shown in FIG. 15(c) (S131: NO), in the proposing window 26, one predicted word 27 can be selected (see the finger drawn with a dashed line). In this case, as shown in FIG. 15(d), the undetermined characters are converted to the determined characters. Based on the conversion (S131: YES), the send button 23 is displayed by moved to a normal position (S111).

### Modification Example 5

As explained in the above modification example 4, the embodiment and the modification examples 1-3 can be combined to each other. As an example different from the one in the modification example 4, the combination of the modification examples 2 and 3 is explained below.

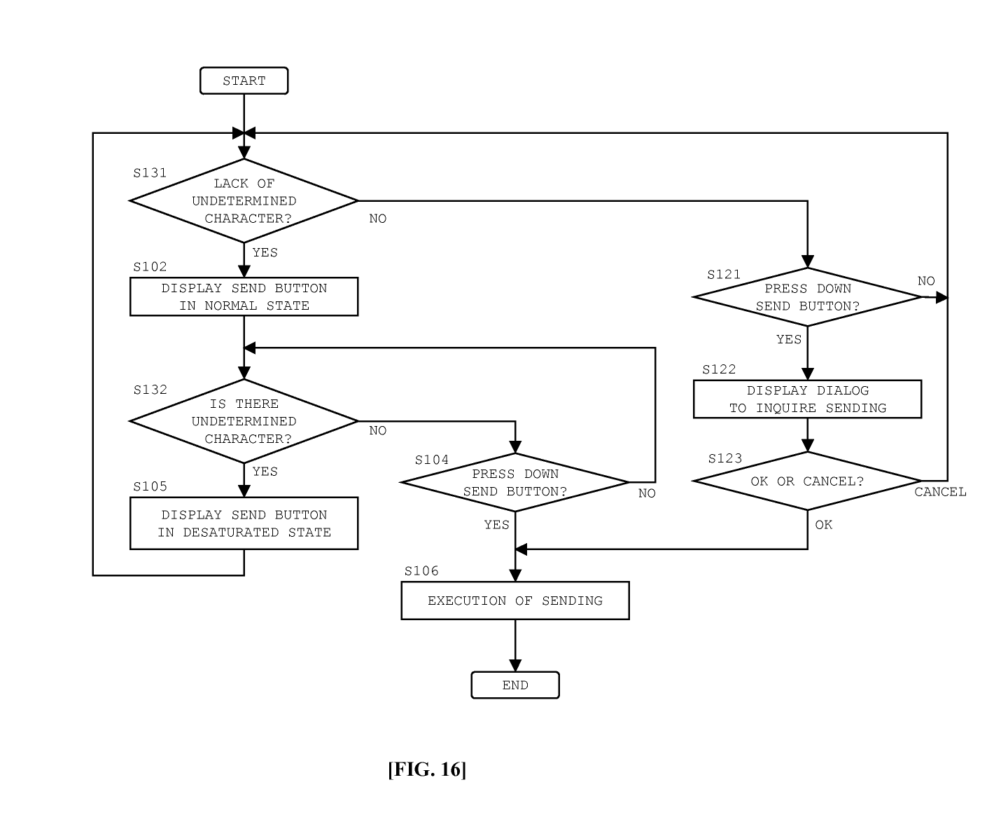

FIG. 16 is a flow chart showing the processing for suppressing sending the message when it is in the middle of inputting characters for creating the text 21b according to modification example 5.

The flow chart of FIG. 16 is a flow chart that replaces the processing of the step S101 with the step S131 and the processing of the step S103 with the step S132 compared with the flow chart of FIG. 9 (the modification example 2).

In the present modification example, when the send button 23 is pressed down while the text 21b includes undetermined characters, as the same with the modification example 2, a dialog inquiring the necessity of sending the message is displayed. Also, in the present modification example, the determination of whether it is in the middle of inputting for creating the text 21b or not is, as the same with the modification example 3, made based on whether the text 21b includes the undetermined characters or not.

### <Others>

The embodiment of the present invention has been described above, but the present invention is not limited to the above embodiment, and the embodiment of the present invention may be variously modified.

In the explanation of the above embodiment and the modification examples 1-5, the case of inputting Japanese characters is used as examples, however types of characters inputted are no object. With alphabetical characters, numbers, signs, characters used in various countries, pictographs, etc., the present invention can be applied to cases a variety of types of characters being input.

Also, in the explanation of the above embodiment and the modification examples 1-5, the keyboard 22 for inputting Japanese characters is used, however a keyboard of an aspect corresponding an input for various types of characters (for example, the QWERTY keyboard corresponding to the input for alphabetical characters) can be used for the keyboard 22 suitably.

In the modification examples 2 and 5, with respect to an inquiry for an advisability for sending a message by displaying the dialog 29, the user needs to specify one or the other clearly whether sending is allowed or canceled. That is, on the dialog 29, a button for allowing (OK) and a button for canceling (CANCEL) are arranged. However, a configuration that allowing or canceling of sending a message is not clearly specified can be employed. For example, the configuration can be employed, in which only one button for designating canceling (CANCEL) of sending is arranged in the dialog box inquiring the advisability of sending the message, and if there is no designation of canceling after the display of the dialog box, within a predetermined time period (for instance, about a few hundred milliseconds-a few seconds), it is considered to be allowed sending the message, and the text 21b is sent as a message to other communication devices.

In the above embodiment, the modification examples 2, 3 and 5, a configuration is employed, in which the saturation of the send button 23 displayed on the display surface 11c decreases while in the middle of input of characters. However a configuration in which the saturation increases can be employed. In addition, a configuration can be employed, in which not only the saturation of the send button 23, but also at least one of the saturation, hue, design, shape, size is changed.

In the above modification example 1 and 4, while the input of characters is performed, the display position of the send button 23 is changed. However, a configuration can be employed, in which the send button 23 is displayed away from the keyboard 22 and the proposing window 26 by changing the display positions of the keyboard 22 and the proposing window 26 or by changing the display positions of the send button 23, the keyboard 22 and the proposing window 26.

Besides, other than the configurations in which the saturation, hue, design and shape of the send button 23 are changed, or the display position is changed in the middle of inputting characters as described above, a configuration can be employed, in which the send button 23 is displayed with a variety of aspects such as enlarged, reduced, etc. Also, while the characters are input, to suppress sending the message for certain, a configuration in which the send button 23 is temporarily hidden can be employed.

The determination processing executed in the above embodiment and the modification examples 1-5 are absolutely examples, and by other information related to input of characters (frequency of pressing down a key, etc.) being further added, various determination processing can be employed. For example, a configuration may be employed, in which it is determined not to be in the middle of the input of characters when the determination conditions applied to the above embodiment and the modification examples 1-5 are fulfilled, and there is no touch operation with respect to the display surface 11c for a predetermined time period (for instance, a few hundred milliseconds-a few ten seconds).

In the above embodiment and the modification examples 1-5, a configuration is employed, in which, when undetermined characters are included in the text 21b, the predicting processing and the proposing processing are executed. However, a configuration can be employed, in which, even when the undetermined characters are included in the text 21b, the predicting processing and the proposing processing are not executed. For example, the configuration that after the undetermined characters are input, according to a key specified by the user in advance being pressed, the predicting processing and the proposing processing are executed can be employed.

In the above embodiment and the modification examples 1-5, one kind of operation related to message sending is accepted by the send button 23, however a configuration in which two or more operations are accepted by the send button 23 may be employed. For instance, a configuration can be employed, in which, in the middle of creating the text 21b, when a normal operation (a tap) is performed to the send button 23, the CPU 100 executes the control to suppress sending the message as mentioned above, and when other than the normal operation (for example, a slide, a flick and a long tap) is performed, the CPU 100 sends a message based on the operation.

In the above embodiment and the modification examples 1-5, examples of applying the present invention when the message is sent during the execution of the text messaging (SMS) is explained. The present invention can be applied not only to the text messaging but also to a web search, for instance.

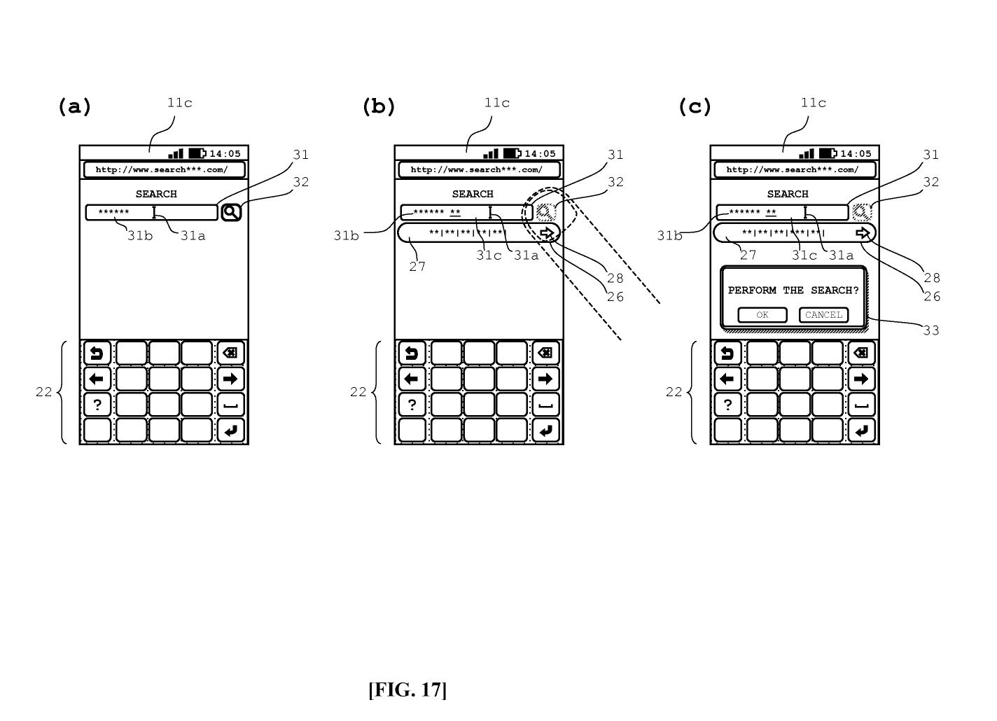

For example, as shown in FIGS. 17(a)-17(c), the present invention (for example, the configuration of the modification example 2) can be applied to the web search. FIGS. 17(a)-17(c) are execution screens of the web search. In FIG. 17(a), the text box 31 for inputting and displaying a search word, a cursor 31a and text 31b which is already input and being in a determined state are displayed on the display surface 11c. Also, a search start button 32 for executing the search with the displayed text 31b as the search word is displayed on the right side of the text box 31 in almost adjacent state. It is noted that the text box 31 corresponds to the above mentioned text box 21, and the search start button 32 corresponds to the above mentioned send button 23.

Here, for example, the user can input undetermined characters with inputting a predetermined word in mind. In this case, the CPU 100 inserts the undetermined characters in the text 31b with an underline 31c. Further, the CPU 100 displays the proposing window 26 on the lower side, almost adjacent to the text box 31 and the search start button 33 by executing the predicting processing and the proposing processing. At this time, as shown in FIG. 17(b), the search start button 33 is displayed in a state that the saturation is decreased (S105). When the user tries to press down the switching button 28 to display more predicted words 27, but the user presses down the search start button 33 by mistake, as shown in FIG. 17(c), on the display surface 11c, a dialog 33 inquiring a start for a search with the currently displayed text 31b as a search word is displayed. Here, the dialog 33 corresponds to the dialog 29 of the modification example 2.

In addition to this, of course, the configurations of the above embodiment, the modification examples 1, 3 and 4 can be applied to the web search.

As such, other than the text messaging and the web search, the present invention can be further applied to various types of functions when the functions are executed, such as sending an e-mail, making a phone call based on a phone number, etc. That is, when it is determined that the characters are being input for using these various functions, the processing for suppressing execution of the function can be executed.

In the above embodiment, the present invention is applied to the smartphone-type cellular phone. However, the present invention can not only to this type, but also be applied to other types of cellular phones such as a bar phone, a flip phone, a slider phone, etc.

Further, the present invention can be applied not only to be limited to a cellular phone, but also to various types of communication devices including a portable terminal device such as a PDA (Personal Digital Assistant), a tablet PC, an e-book reader, etc.

The embodiment of the present invention may be modified variously and suitably within the scope of the technical idea described in claims.

### REFERENCE SIGNS LIST

1 Cellular phone
11c Display surface
12 Touch sensor
21b Text
22 Keyboard
26 Proposing window
27 Predicted words
23 Send button
100 CPU
107 Communication module

1. A portable terminal device, comprising:
a display surface;
an accepting module configured to accept an input with respect to an image displayed on the display surface;
a display control module configured to display a first image for inputting characters, one or more inputted characters and a second image for executing a predetermined function based on the one or more inputted characters on the display surface; and
a suppressing module configured to execute a suppressing control for suppressing the execution of the predetermined function while one or more undetermined characters are included in displayed characters on the display surface.

2. The portable terminal device according to claim 1, wherein
the display control module displays a third image on the display surface as at least a part of the first image, the third image being an image for selecting one or more characters which become one or more determined characters among changing candidates one of which becomes the one or more determined characters by changing the one or more undetermined characters, and the suppressing module executes the suppressing control while the third image is displayed on the display surface.

3. The portable terminal device according to claim 2, wherein
the display control module displays a fourth image on the display surface as at least a part of the first image, the fourth image being a image for selecting one or more characters following the one or more determined characters among input candidates one of which is predicted to be input following the one or more determined characters, and
the suppressing module executes the suppressing control while the fourth image is displayed on the display surface.

4. The portable terminal device according to claim 1,
wherein
the suppressing module executes a control as the suppressing control for displaying the first image and the second image to be apart from each other on the display surface compared to a time when the suppressing control is not performed.

5. The portable terminal device according to claim 1,
wherein
the suppressing module executes a control as the suppressing control for not executing the predetermined function even when an input is performed with respect to the second image.

6. The portable terminal device according to claim 1,
wherein
the suppressing module changes at least one of saturation, hue, design, shape and size of the second image compared to before the suppressing control is executed while the suppressing control is executed.

7. The portable terminal device according to claim 1,
wherein
the suppressing module executes a control as the suppressing control for inquiring a necessity of execution of the predetermined function when an input is performed with respect to the second image.

8. The portable terminal device according to claim 1,
wherein
the suppressing module performs a control as the suppressing control for deleting the second image from the display surface.

9. The portable terminal device according to claim 1,
wherein
the first image includes soft keys for inputting the characters.

10. The portable terminal device according to claim 1,
further comprising:
a sending module configured to send information including at least one or more characters to a predefined destination, and wherein
the predetermine function includes a function for sending the one or more inputted characters to the destination.

11. A non-transitory storage medium holding a computer program which provides
a computer of a portable terminal device comprising a display surface and an accepting module configured to accept an input with respect to the display surface with functions of:
displaying one or more characters inputted through the accepting module and an image for executing a predetermined function based on the one or more inputted characters on the display surface;
obtaining an input with respect to the image as an input for executing the predetermined function; and
suppressing the execution of the predetermined function while one or more undetermined characters are included in displayed characters on the display surface.

12. A method for suppressing an implementation of a portable terminal device
comprising a display surface and an accepting module configured to accept an input with respect to an image displayed on the display surface, wherein the execution suppressing method comprising steps of:
displaying a first image for inputting characters, one or more inputted characters and a second image for executing a predetermined function based on the one or more inputted characters on the display surface; and
suppressing the execution of the predetermined function while one or more undetermined characters are included in displayed characters on the display surface.
